(19) United States
(12) Patent Application Publication
(10) Pub. No.: US 2015/0121744 A1
(43) Pub. Date: May 7, 2015

(54) Capturing Apparatus And Related Methods

(71) Applicant: Ryan Patrick Coppola, Sparks, NY (US)

(72) Inventor: Ryan Patrick Coppola, Sparks, NY (US)

(21) Appl. No.: 14/536,479

(22) Filed: Nov. 7, 2014

Related U.S. Application Data
(63) Continuation-in-part of application No. 13/589,154, filed on Aug. 19, 2012, now abandoned.

(51) Int. Cl. A01M 3/00; A01M 5/02

(52) U.S. Cl. CPC A01M 3/002; A01M 5/02
USPC 43/110

(57) ABSTRACT

A capturing apparatus and related methods of use and manufacture. A capturing apparatus is used to humanely and effectively capture objects using a capturing structure having an upper portion, a lower portion, a proximal end, and a distal end. A valve is coupled to the capturing structure to prevent the release of the object once captured. An elongated member having a proximal end and a distal end has a contoured gripping feature on the proximal end of the elongated member, with the elongated member coupled at the distal end of the elongated member to the proximal end of the capturing structure. A holding structure is coupled to the upper portion of the capturing structure to contain the object once captured.

### CROSS-REFERENCE TO RELATED APPLICATION(S)

This document is a continuation-in-part application of and claims priority to, and the benefit of, U.S. Non-Provisional patent application Ser. No. 13/589,154, filed on Aug. 19, 2012, entitled “FLY SWOOPER,” herein incorporated by reference in its entirety for all purposes.

### TECHNICAL FIELD

The present disclosure technically relates to the field of capturing objects, such as insects. More particularly, the present disclosure technically relates to the field of capturing and releasing objects. Even more particularly, the present disclosure technically relates to the field of capturing and releasing objects using fluid forces, such as aerodynamic forces.

### BACKGROUND

Household pests, particularly flies, bees, moths, and wasps, are present in nearly every residential and commercial setting imaginable. Typically, such flying insects are squashed and killed with a flat device, commonly, a fly swatter, when the flying insects land on a flat surface. However, such a situation requires cooperation on the part of the flying insect, and disposal of the remains once the flying insect is terminated. Alternatively, flying insects may be captured by a vapor-emitting strip, which slowly diffuses a deep, penetrating vapor throughout an enclosed treatment space for a limited period of time. However, a vapor-emitting strip may not be used for an extended period of time in an area occupied by humans. Chemical sprays may also be used to neutralize flying insects, but their purpose in killing may deter those users that simply want to remove, rather than kill, the flying insects.

In the related art, U.S. Pat. No. 404,946 to Andersson discloses a dip-net of fine netting having the open end attached to the wire hoof of a staff, with the open bottom end drawn or gathered closed by a string. Although to release a fly, the netting bottom end must be untied by way of a cumbersome tie portion, wherein the user must expend a great deal of time manipulating the tie portion in order to release the fly. In addition, the user's hands may inadvertently make contact with the fly during such undue manipulation of the tie portion.

However, the related art swatting or capturing apparatuses respectively kill the insect or do not properly contain the insect once captured. As such, a long-felt need exists for an apparatus that is humane, sanitary, quick, easy to use, aesthetically pleasing, non-toxic, portable, contains an insect for an unlimited period of time, and is cost-effective to produce.

### SUMMARY

In addressing many of the problems experienced in the related art swatting or capturing apparatuses, the present disclosure describes a capturing apparatus that is humane, sanitary, quick and easy to use, aesthetically pleasing, non-toxic, portable, capable of containing an insect for an unlimited period of time, and cost-effective to produce.

In general, the present disclosure encompasses a capturing apparatus, the apparatus comprising: a capturing structure having an upper portion and a lower portion; a valve coupled with the capturing structure; an elongated member having a proximal end and a distal end, the elongated member coupled with the capturing structure; and a holding structure, having an upper portion and a lower portion, coupled with the capturing structure, in accordance with an embodiment of the present disclosure.

Further, the present disclosure encompasses a method of fabricating a capturing apparatus, the method comprising: providing a capturing structure having an upper portion and a lower portion; providing a valve coupled with the capturing structure; providing an elongated member having a proximal end and a distal end, the elongated member coupled with the capturing structure; and providing a holding structure, having an upper portion and a lower portion, coupled with the capturing structure, in accordance with an embodiment of the present disclosure.

Furthermore, the present disclosure encompasses a method of using a capturing apparatus, comprising: providing the capturing apparatus, the capturing apparatus providing comprising: providing a capturing structure having an upper portion and a lower portion; providing a valve coupled with the capturing structure; providing an elongated member having a proximal end and a distal end, the elongated member coupled with the capturing structure; and providing a holding structure, having an upper portion and a lower portion, coupled with the capturing structure; and swooping the apparatus in relation to an object, thereby capturing the object, in accordance with an embodiment of the present disclosure.

Benefits of the capturing apparatus and methods, in accordance with the present disclosure, include, but are not limited to, quick and ready deployability, non-toxicity, portability, unlimited containment, and easy fabrication. These and other objectives and advantages of the disclosure will become apparent from the following description taken in conjunction with the accompanying drawings wherein and set forth, by way of illustration and example, certain embodiments of the invention. The drawings are intended to constitute a part of this specification and include exemplary embodiments of the present disclosure and illustrate various objects and features thereof.

### BRIEF DESCRIPTION OF THE DRAWING

The above, and other, aspects, features, and advantages of several embodiments of the present disclosure will be more apparent from the following Detailed Description as presented in conjunction with the following several figures of the Drawing.

FIG. 1A is a diagram illustrating a side view of a capturing apparatus, comprising a valve coupled to a lower portion of a capturing structure, in accordance with an embodiment of the present disclosure.

FIG. 1B is a diagram illustrating a side view of a capturing apparatus, comprising a valve coupled to an upper portion of a capturing structure, in accordance with an embodiment of the present disclosure.

FIG. 2A is a diagram illustrating a cutaway top view of a capturing apparatus, comprising a capturing structure having an elliptical configuration, in accordance with an embodiment of the present disclosure.

FIG. 2B is a diagram illustrating a cutaway top view of a capturing apparatus, comprising a capturing structure having a round configuration, in accordance with an embodiment of the present disclosure.

FIG. 3 is a diagram illustrating a cutaway side view of a capturing apparatus, comprising a valve coupled with a lower portion of a capturing structure, in accordance with an embodiment of the present disclosure.

FIG. 3A is a diagram illustrating a top view of a valve, such as included by a capturing apparatus, the valve comprising two segments, in accordance with an embodiment of the present disclosure.

FIG. 3B is a diagram illustrating a top view of a valve, such as included by a capturing apparatus, the valve comprising three segments, in accordance with an embodiment of the present disclosure.

FIG. 3C is a diagram illustrating a top view of a valve, such as included by a capturing apparatus, the valve comprising four segments, in accordance with an embodiment of the present disclosure.

FIG. 3D is a diagram illustrating a top view of a valve, such as included by a capturing apparatus, the valve comprising eight segments, in accordance with an embodiment of the present disclosure.

FIG. 3E is a diagram illustrating a top view of a valve, such as included by a capturing apparatus, the valve comprising twelve segments, in accordance with an embodiment of the present disclosure.

FIG. 4A is a diagram illustrating a cut-away side view of a capturing apparatus, comprising a capturing structure, a valve, and a holding structure having a releasable member, in accordance with an embodiment of the present disclosure.

FIG. 4B is a diagram illustrating a perspective side view of a holding structure, such as included by a capturing apparatus, the holding structure comprising a removable coupling structure and a releasable member, in accordance with an embodiment of the present disclosure.

FIG. 5 is a flowchart illustrating a method of fabricating a capturing apparatus, in accordance with an embodiment of the present disclosure.

FIG. 6 is a flowchart illustrating a method of using a capturing apparatus, in accordance with an embodiment of the present disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures may be emphasized relative to other elements for facilitating understanding of the various presently disclosed embodiments. Also, common, but well-understood, elements that are useful or necessary in commercially feasible embodiment are often not depicted in order to facilitate a less obstructed view of these various embodiments of the present disclosure.

### DETAILED DESCRIPTION

The following description is not to be taken in a limiting sense, but is made merely for the purpose of describing the general principles of exemplary embodiments. The scope of the disclosure should be determined with reference to the Claims. Reference throughout this specification to “one embodiment,” “an embodiment,” or similar language means that a particular feature, structure, or characteristic that is described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

Further, the described features, structures, or characteristics of the present disclosure may be combined in any suitable manner in one or more embodiments. In the Detailed Description, numerous specific details are provided for a thorough understanding of embodiments of the disclosure. One skilled in the relevant art will recognize, however, that the embodiments of the present disclosure can be practiced without one or more of the specific details, or with other methods, components, materials, and so forth. In other instances, well-known structures, materials, or operations are not shown or described in detail to avoid obscuring aspects of the present disclosure.

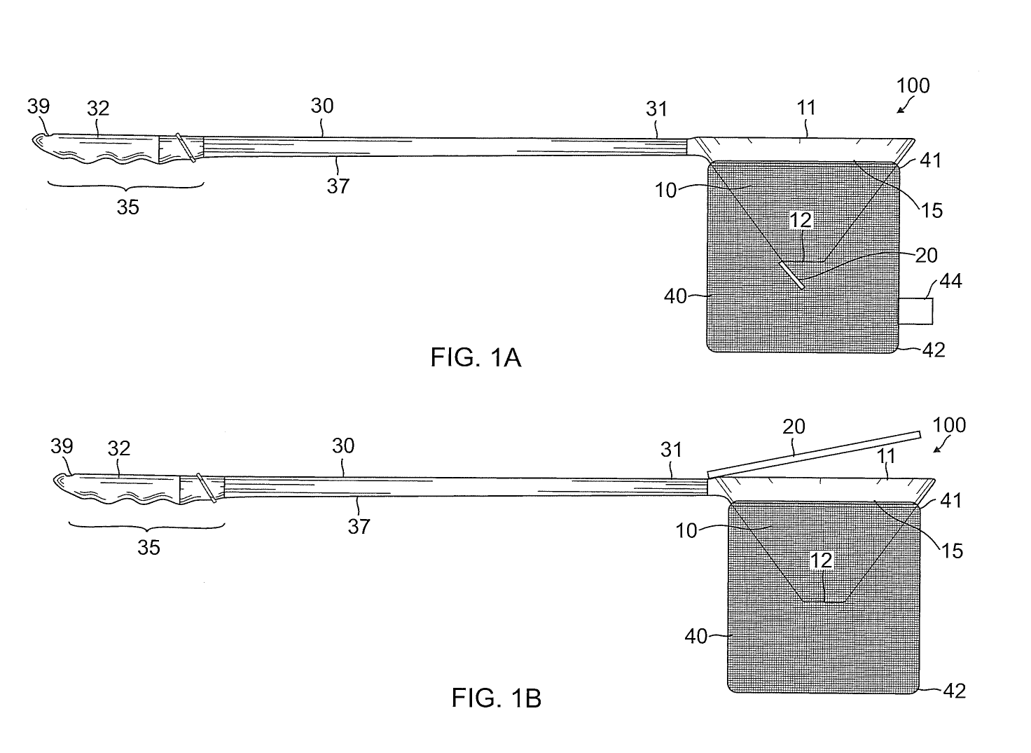

Referring to FIG. 1A, this diagram illustrates a side view of a capturing apparatus 100, comprising a valve 20 coupled to a lower portion 12 of a capturing structure 10, in accordance with an embodiment of the present disclosure. The capturing apparatus 100 has the benefit of humanely and sanitarily capturing and releasing a flying or swimming (or generally aquatic) object, such as a flying insect, a small bird, a small fish, a small amphibian, and a small crustacean. The capturing apparatus 100 generally comprises: a capturing structure 10 having an upper portion 11 and a lower portion 12; a valve 20 coupled with the capturing structure 10; an elongated member 30 having a proximal end 31 and a distal end 32, the elongated member 30 coupled with the capturing structure 10; and a holding structure 40, having an upper portion 41 and a lower portion 42, coupled with the capturing structure 10.

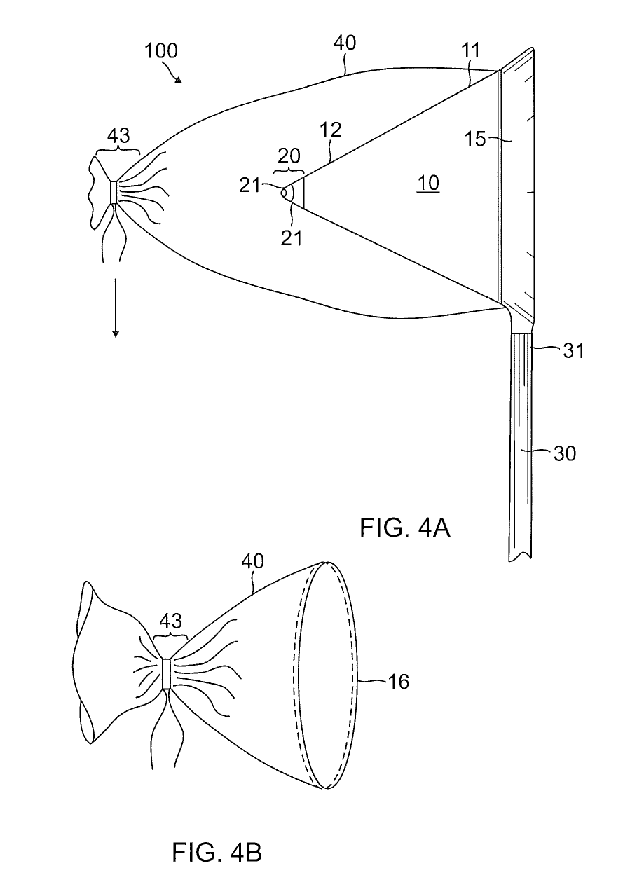

Still referring to FIG. 1A, in an embodiment, the valve 20 comprises a single flap by example only, and is coupled with the lower portion 12 of the capturing structure 10. In an embodiment, the capturing apparatus 100 further comprises a gripping feature 35 disposed at the distal end 32 of the elongated member 30. In an embodiment, the holding structure 40 may be removably coupled with the capturing structure 10, such as for facilitating releasing the flying object. In an alternative embodiment, the holding structure 40 is capable of opening at the lower portion 42 by way of a releasable member 43 (See also FIGS. 4A and 4B.), such as for facilitating releasing the flying object. The releasable member 43 comprises at least one of a tab loop, a grommet, a casing, a snap, a sliding feature, a magnetic feature, a hook-and-loop fastener, a rod, a pin, a hinge structure, and the like. In an embodiment, the capturing structure 10 comprises at least one shape of a pyramid, a prism, a cube, a cylinder, a cone, a frusto-cone, a sphere, a semi-sphere, a paraboloid, a hyperboloid, an ellipsoid, an epicycloid, a nephroid, and the like.

Still referring to FIG. 1A, in another embodiment, the capturing apparatus 100 further comprises an actuator 37 for actuating the valve 20. The valve 20 is configured to open via the actuator 37; and the actuator 37 is coupled with both the gripping feature 35 and the valve 20. The actuator 37 may comprise at least one of a gear, a rail, a pulley, a chain, a linkage, a spring, a wire, a rod, a cable, a belt, a wheel and axle, a rack and pinion, and the like (not shown). In yet another embodiment, the capturing apparatus 100 further comprises at least one hanging feature 39, the at least one hanging feature comprising at least one of a through-hole, a hook, an eye, an adhesive feature, and the like.

Still referring to FIG. 1A, in an embodiment, the capturing apparatus 100 further comprises an indicia feature 44 coupled with at least one of the capturing structure 10, the holding structure 40, the elongated member 30, and the gripping feature 35, wherein the indicia feature 44 comprises at least one of a product marking, a patent marking, a product source, a trademark, a logo, a website address, a copyright notice, any identifying information, and the like. In an embodiment, the capturing structure 10 comprises a coupling feature 15 for facilitating coupling and decoupling of the holding structure 40 therefrom. The coupling feature 15 comprises at least one of a ridge, a crest, a point, a rim, an indent, an edge, a lip, a brim, a magnet, and the like. The gripping feature 35 comprises at least one of a knurled feature, a complementary-finger-shaped feature, a rubberized feature, a silicone material, an elastic material, a foam material, a memory-foam material, and the like.

Referring to FIG. 1B, this diagram illustrates a side view of a capturing apparatus 100, comprising a valve 20 coupled with an upper portion 12 of a capturing structure 10, in accordance with an embodiment of the present disclosure. The capturing apparatus 100 has the benefit of humanely and sanitarily capturing and releasing a flying or swimming (or generally aquatic) object, such as a flying insect, a small bird, a small fish, a small amphibian, and a small crustacean. The capturing apparatus 100 generally comprises: a capturing structure 10 having an upper portion 11 and a lower portion 12; a valve 20 coupled with the capturing structure 10; an elongated member 30 having a proximal end 31 and a distal end 32, the elongated member 30 coupled with the capturing structure 10; and a holding structure 40, having an upper portion 41 and a lower portion 42, coupled with the capturing structure 10.

Still referring to FIG. 1B, in an alternative embodiment, the valve 20 is coupled to the upper portion 11 of the capturing structure 10 and is capable of closing the capturing structure 10 in a lid-like manner by example only. In an embodiment, the capturing apparatus 100 further comprises a gripping feature 35 disposed at the distal end 32 of the elongated member 30. In an embodiment, the holding structure 40 is configured to open at its lower portion 42 by way of a releasable member 43 (See also FIGS. 4A and 4B.). The releasable member 43 comprises at least one of a tab loop, a grommet, a casing, a snap, a sliding feature, a magnetic feature, a hook-and-loop fastener, a rod, a pin, a hinge structure, and the like. In an embodiment, the capturing structure 10 comprises at least one shape of a pyramid, a prism, a cube, a cylinder, a cone, a frusto-cone, a sphere, a semi-sphere, a paraboloid, a hyperboloid, an ellipsoid, an epicycloid, and a nephroid.

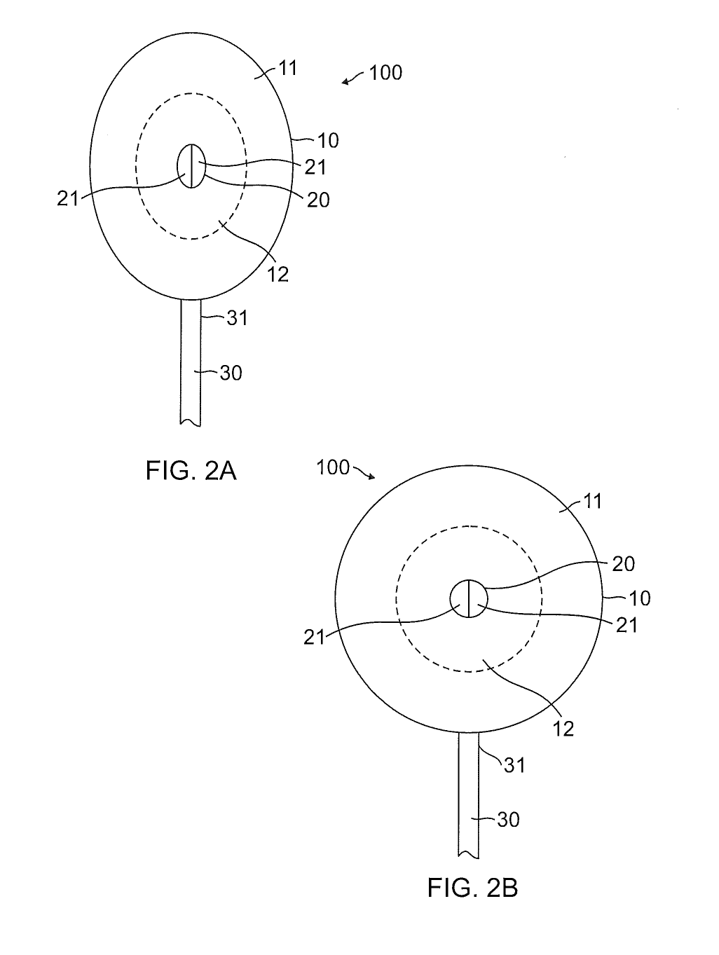

Referring to FIG. 2A, this diagram illustrates a cut-away top view of a capturing apparatus 100, comprising a capturing structure 10 having an elliptical configuration, in accordance with an embodiment of the present disclosure. In an embodiment, the capturing structure 10 is shaped like an oval. However, other shapes are also contemplated, such as any polygon (triangle, quadrilateral (kite, parallelogram, trapezoid, rectangle, square), pentagon, hexagon, heptagon, octagon, nonagon, decagon, and so on), circle, or crescent. The capturing structure 10 is coupled with the valve 20 having at least one segment 21, wherein the valve 20 also comprises an elliptical shape by example only, but may alternatively comprise a shape that is distinct from that of the capturing structure 10.

Referring to FIG. 2B, this diagram illustrates a cut-away top view of an capturing apparatus 100, comprising a capturing structure 10 having a round configuration, in accordance with an embodiment of the present disclosure. In an embodiment, the capturing structure 10 is shaped like a circle. However, other shapes are also contemplated, such as any polygon (triangle, quadrilateral (kite, parallelogram, trapezoid, rectangle, square), pentagon, hexagon, heptagon, octagon, nonagon, decagon, and so on), oval, or crescent. The capturing structure 10 is coupled with the valve 20 having at least one segment 21, wherein the valve 20 also comprises a round shape by example only, but may alternatively comprise a shape that is distinct from that of the capturing structure 10.

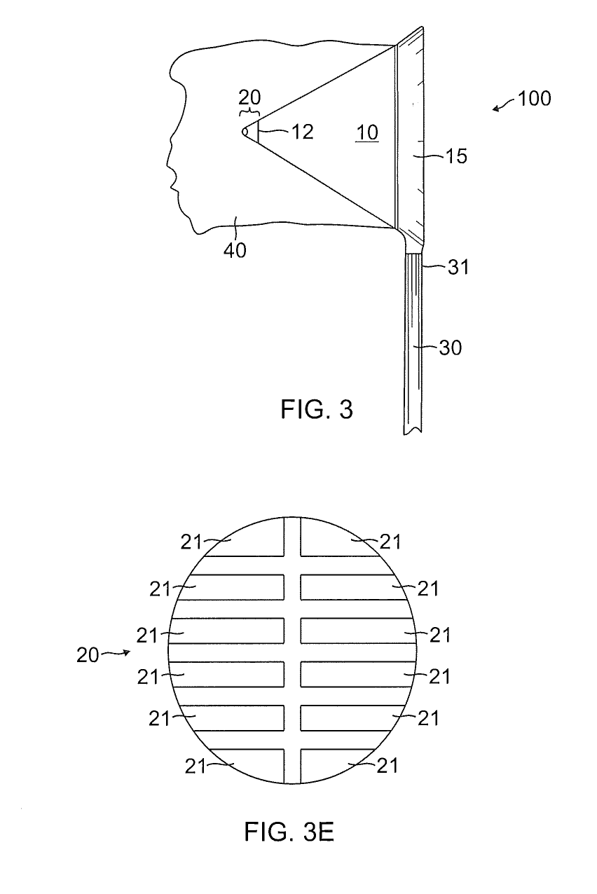

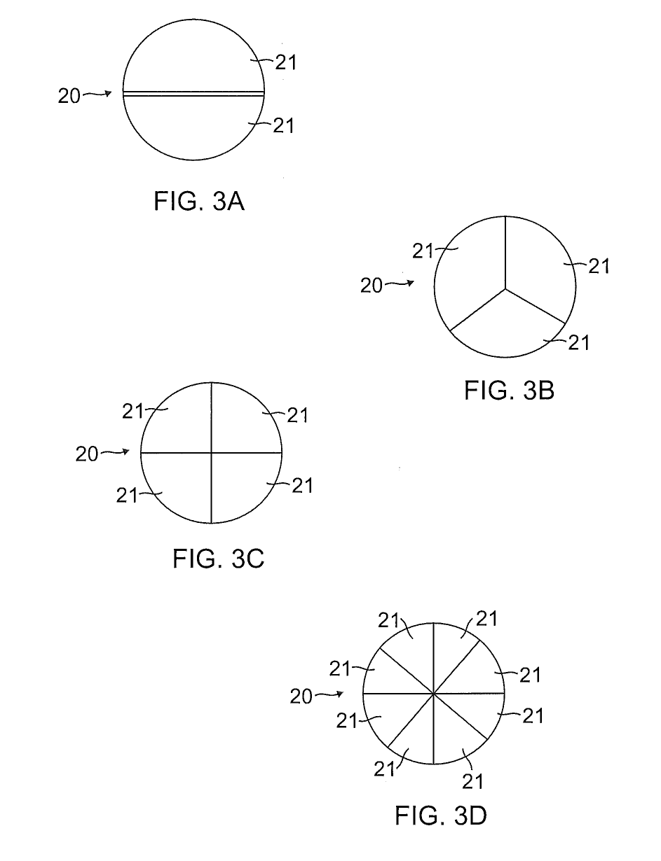

FIG. 3 is a diagram illustrating a cut-away side view of a capturing apparatus 100, generally comprising: a capturing structure 10 having an upper portion 11 and a lower portion 12; a valve 20 coupled with the capturing structure 10; an elongated member 30 having a proximal end 31 and a distal end 32 (not shown), the elongated member 30 coupled with the capturing structure 10; and a holding structure 40, having an upper portion 41 and a lower portion 42, coupled with the capturing structure 10, in accordance with an embodiment of the present disclosure. In various embodiments, the valve 20 comprises at least one of: a one-way valve, a valve actuable by an aerodynamic force, a valve actuable by a mechanical force, and the like.

Referring to FIG. 3A, this diagram illustrates a top view of a valve 20 of a capturing apparatus 100, the valve 20 comprising a plurality of segments 21, such as two segments, in accordance with an embodiment of the present disclosure. The valve 20 is disposable at either the upper portion 11 of the capturing structure 10 or the lower portion 12 of the capturing structure 10. The valve 20 may be partially, or completely, coupled with the capturing structure 10, such partially, or completely, coupled with at least one surface of an interior surface and an exterior surface of the capturing structure 10. In an embodiment, the valve 20 comprises two segments created by one slit, by example only. The plurality of segments 21 may be flush or spaced apart in relation to one another.

Referring to FIG. 3B, this diagram illustrates a top view of a valve 20 of a capturing apparatus 100, the valve 20 comprising a plurality of segments 21, such as three segments, in accordance with an embodiment of the present disclosure. The valve 20 is disposable at either the upper portion 11 of the capturing structure 10 or the lower portion 12 of the capturing structure 10. The valve 20 may be partially, or completely, coupled with the capturing structure 10, such partially, or completely, coupled with at least one surface of an interior surface and an exterior surface of the capturing structure 10. In an embodiment, the valve 20 comprises two segments created by one slit, by example only. The plurality of segments 21 may be flush or spaced apart in relation to one another.

Referring to FIG. 3C, this diagram illustrates a top view of a valve 20 of a capturing apparatus 100, the valve 20 comprising a plurality of segments 21, such as four segments, in accordance with an embodiment of the present disclosure. The valve 20 is disposable at either the upper portion 11 of the capturing structure 10 or the lower portion 12 of the capturing structure 10. The valve 20 may be partially, or completely, coupled with the capturing structure 10, such partially, or completely, coupled with at least one surface of an interior surface and an exterior surface of the capturing structure 10. In an embodiment, the valve 20 comprises two segments created by one slit, by example only. The plurality of segments 21 may be flush or spaced apart in relation to one another.

Referring to FIG. 3D, this diagram illustrates a top view of a valve 20 of a capturing apparatus 100, the valve 20 comprising a plurality of segments 21, such as eight segments, in accordance with an embodiment of the present disclosure. The valve 20 is disposable at either the upper portion 11 of the capturing structure 10 or the lower portion 12 of the capturing structure 10. The valve 20 may be partially, or completely, coupled with the capturing structure 10, such partially, or completely, coupled with at least one surface of an interior surface and an exterior surface of the capturing structure 10. In an embodiment, the valve 20 comprises two segments created by one slit, by example only. The plurality of segments 21 may be flush or spaced apart in relation to one another.

FIG. 3E is a diagram illustrating a top view of a valve 20 of a capturing apparatus 100, the valve 20 comprising a plurality of segments 21, such as twelve segments, in accordance with an embodiment of the present disclosure. The valve 20 is disposable at either the upper portion 11 of the capturing structure 10 or the lower portion 12 of the capturing structure 10. The valve 20 may be partially, or completely, coupled with the capturing structure 10, such partially, or completely, coupled with at least one surface of an interior surface and an exterior surface of the capturing structure 10. In an embodiment, the valve 20 comprises two segments created by one slit, by example only. The plurality of segments 21 may be flush or spaced apart in relation to one another.

FIG. 4A is a diagram illustrating a cut-away side view of a capturing apparatus 100, generally comprising: a capturing structure 10 having an upper portion 11 and a lower portion 12; a valve 20 coupled with the capturing structure 10; an elongated member 30 having a proximal end 31 and a distal end 32 (not shown), the elongated member 30 coupled with the capturing structure 10; and a holding structure 40, having an upper portion 41 and a lower portion 42, coupled with the capturing structure 10, in accordance with an embodiment of the present disclosure. In an embodiment, the valve 20 is coupled with the lower portion 12 of the capturing structure 10. In an alternative embodiment, the holding structure 40 is capable of opening at the lower portion 42 by way of a releasable member 43 (See also FIGS. 4A and 4B.), such as for facilitating releasing the flying object. The releasable member 43 comprises at least one of a tab loop, a grommet, a casing, a snap, a sliding feature, a magnetic feature, a hook-and-loop fastener, a rod, a pin, a hinge structure, and the like, wherein the releasable member 43 is quickly releasable for facilitating release of an object, such as a fluid-traveling object, as well as for minimizing contact with the object.

FIG. 4B is a diagram illustrating a side view of a holding structure 40, such as included by a capturing apparatus 100, the holding structure 40 comprising a movable coupling structure and a releasable member 43, in accordance with an embodiment of the present disclosure. In an alternative embodiment, the holding structure 40 is capable of opening at the lower portion 42 by way of a releasable member 43 (See also FIGS. 4A and 4B.), such as for facilitating releasing the flying object. The releasable member 43 comprises at least one of a tab loop, a grommet, a casing, a snap, a sliding feature, a magnetic feature, a hook-and-loop fastener, a rod, a pin, a hinge structure, and the like, wherein the releasable member 43 is quickly releasable for facilitating release of an object, such as a fluid-traveling object, as well as for minimizing contact with the object. The holding structure 40 further comprises a coupling feature 16 being complementary in relation to the coupling feature 15 of the capturing structure 10. The holding structure coupling feature 16 comprises at least one of a casing, an elastic member, a drawstring, a hook-and-loop fastener, a complementary magnet, and the like.

Referring back to FIGS. 1-4, the elongated member 30 is coupled, at the proximal end 31, with the capturing structure 10. In an embodiment, the elongated member 30 is integrally formed with the capturing structure 40. In another embodiment, the elongated member 30 is releasable from the capturing structure 10. In yet another embodiment, the elongated member 30 is configured to be telescoping and collapsible. Also, the holding structure 40, having an upper end 41 and a lower end 42, is removably coupled with upper portion 11 of the capturing structure 10, such as by way of the complementary coupling features, 15, 16. In an alternative embodiment, the holding structure 40 is integrally formed with the capturing structure 10. In an alternative embodiment, the holding structure 40 is releasable from the capturing structure 10.

Still referring back to FIGS. 1-4, as discussed, the holding structure 40 has an upper end 41 and a lower end 42, and may be configured to open at the lower end 42 by way of a releasable member 43. In an embodiment, the releasable member 43 of the holding structure 40 comprises at least one of a tab loop, a grommet, a casing, a snap, a sliding feature, a magnetic feature, a hook-and-loop fastener, a rod, a pin, a hinge structure, and the like. In an embodiment, the holding structure 40 comprises at least one of a porous material, a mesh material, a screen material, a tarp material, a paper material, a polymeric material, an elastic material, and an adhesive material.

Still referring back to FIGS. 1-4, the valve 20 is coupled to the capturing structure 10. In an embodiment, the valve 20 is configured to open via an actuator 37 actuated by a user (See FIG. 1A.). In an embodiment, the actuator 37 is coupled at each end to both the gripping feature 35 and the valve 20. The actuator 37 may be located inside or alongside the elongated member 30. The actuator 37 may comprise a pull tab attached to a wire, a strip, a rod, or the like (not shown). In an embodiment, the valve 20 is one of at least a one-way valve, a valve actuable by an aerodynamic force, and a valve actuable by a mechanical force.

Still referring back to FIGS. 1-4, the capturing structure 10 and elongated member 30 each comprise at least one material of a polymeric material, a metallic material, a ceramic material, a composite material, and any combination thereof. Specifically, the material may include at least one material of: a high density polyethylene (HDPE), an ultra-high molecular weight polyethylene fiber, a vulcanized rubber, an aluminum material, and aluminum alloy material, a polyvinyl chloride (PVC) material, a polycarbonate, a polystyrene, an acrylonitrile-butadiene-styrene (ABS) plastic, such as a monolayer and a co-extruded multilayer ABS, an ABS/PVC alloy, an acrylic material, such as polymethyl methacrylate (PMMA), a polyethylene terephthalate (PETG), and the like.

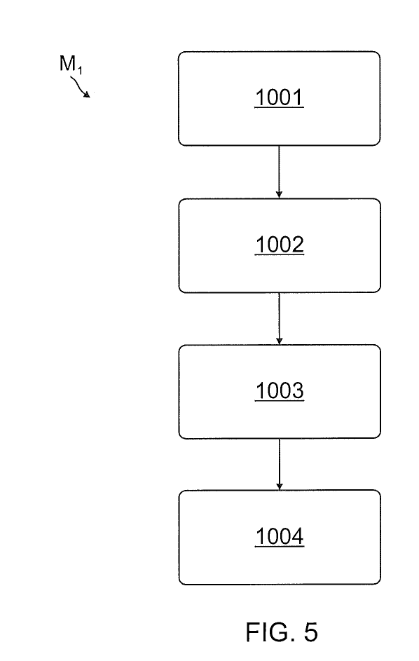

Referring to FIG. 5, this flowchart illustrates a method M₁ of fabricating a capturing apparatus 100, such as shown in FIGS. 1-4, in accordance with an embodiment of the present disclosure. The method M₁ of method of fabricating an capturing apparatus 100 comprises: providing a capturing structure 10 having an upper portion 11 and a lower portion 12, as indicated by block 1001; providing a valve 20 coupled with the capturing structure 10, as indicated by block 1002; providing an elongated member 30 having a proximal end 31 and a distal end 32, the elongated member 30 coupled with the capturing structure 10, as indicated by block 1003; and providing a holding structure 40, having an upper portion 41 and a lower portion 42, coupled with the capturing structure 10, as indicated by block 1004, in accordance with an embodiment of the present disclosure.

Still referring to FIG. 5, in the method M₁, the valve 20 providing, as indicated by block 1002, comprises providing at least one of a one-way valve, a valve actuable by an aerodynamic force, and a valve actuable by a mechanical force. The method M₁ further comprises providing an actuator 37 for actuating the valve 20 (See also FIG. 1A.). The actuator 37 providing comprises providing at least one of a gear, a rail, a pulley, a chain, a linkage, a spring, a wire, a rod, a cable, a belt, a wheel and axle, a rack and pinion, and the like. The capturing structure 10 providing, as indicated by block 1001, comprises providing at least one of a ridge, a crest, a point, a rim, an indent, an edge, a lip, a brim, and the like.

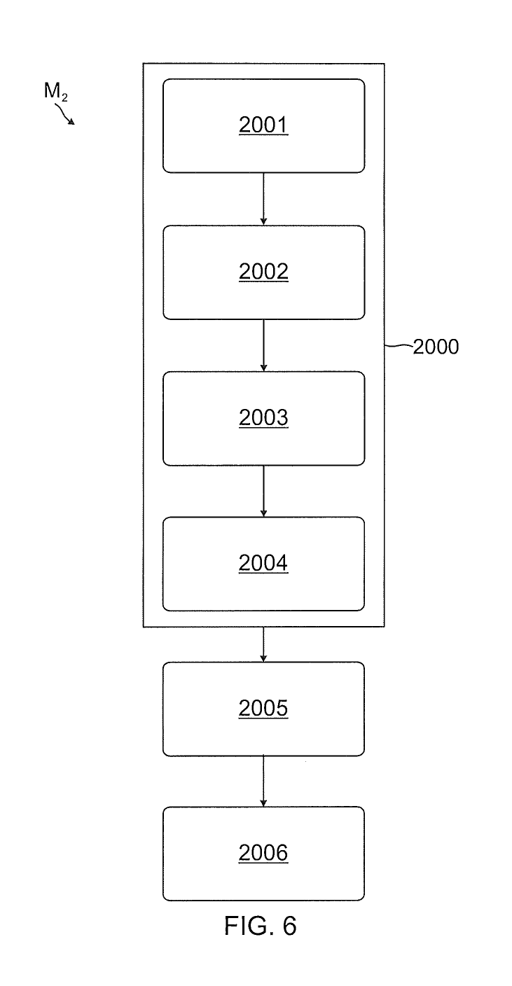

Referring to FIG. 6, this flowchart illustrates a method of using an capturing apparatus 100, such as shown in FIGS. 1-4, in accordance with an embodiment of the present disclosure. The method M₂ of using a capturing apparatus 100, comprises: providing the capturing apparatus 10, as indicated by block 2000, the capturing apparatus 10 providing comprising: providing a capturing structure 10 having an upper portion 11 and a lower portion 12, as indicated by block 2001; providing a valve 20 coupled with the capturing structure 10, as indicated by block 2002; providing an elongated member 30 having a proximal end 31 and a distal end 32, the elongated member 30 coupled with the capturing structure 10, as indicated by block 2005; and providing a holding structure 40, having an upper portion 41 and a lower portion 42, coupled with the capturing structure 10, as indicated by block 2004; and swooping the capturing apparatus 10 in relation to an object, thereby capturing the object, as indicated by block 2005, in accordance with an embodiment of the present disclosure. The method M₂ further comprises releasing the object, as indicated by block 2006.

Information as herein shown and described in detail is fully capable of attaining the above-described object of the present disclosure, the presently preferred embodiment of the present disclosure, and is, thus, representative of the subject matter that is broadly contemplated by the present disclosure. The scope of the present disclosure fully encompasses other embodiments which may become obvious to those skilled in the art, and is to be limited, accordingly, by nothing other than the appended claims, wherein any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for such to be encompassed by the present claims. Furthermore, no element, component, or method step in the present disclosure is intended to be dedicated to the public regardless of whether the element, component, or method step is explicitly recited in the claims. However, that various changes and modifications in form, material, work-piece, and fabrication material detail may be made, without departing from the spirit and scope of the present disclosure, as set forth in the appended claims, as may be apparent to those of ordinary skill in the art, are also encompassed by the present disclosure.

What is claimed:

1. A capturing apparatus, the apparatus comprising:
a capturing structure having an upper portion and a lower portion;
a valve coupled with the capturing structure;
an elongated member having a proximal end and a distal end, the elongated member coupled with the capturing structure; and
a holding structure, having an upper portion and a lower portion, coupled with the capturing structure.

2. The apparatus of claim 1, further comprising a gripping feature disposed at the distal end of the elongated member.

3. The apparatus of claim 1, wherein the elongated member is one of: integrally formed with the capturing structure; and releasable from the capturing structure.

4. The apparatus of claim 1, wherein the holding structure is one of:
integrally formed with the capturing structure; and
releasable from the capturing structure.

5. The apparatus of claim 1, wherein the holding structure upper portion is configured to removably couple with the capturing structure upper portion.

6. The apparatus of claim 1,
wherein the capturing structure is configured to open by way of a releasable member for quick-releasability; and
wherein the releasable member comprises at least one of a tab loop, a grommet, a casing, a snap, a sliding feature, a magnetic feature, a hook-and-loop fastener, a rod, a pin, a hinge structure, and the like.

7. The apparatus of claim 1, wherein the holding structure comprises at least one of a porous material, a mesh material, a screen material, a tarp material, a paper material, a polymeric material, an elastic material, an adhesive material, and the like.

8. The apparatus of claim 1, further comprising an actuator for actuating the valve.

9. The apparatus of claim 1, wherein the capturing structure and the elongated member each comprise at least one material of a polymeric material, a metallic material, a ceramic material, a composite material, and the like.

10. The apparatus of claim 1, wherein the valve comprises at least one of: a one-way valve, a valve actuable by an aerodynamic force, a valve actuable by a mechanical force, and the like.

11. The apparatus of claim 1, wherein the elongated member is configured to telescope and collapse.

12. The apparatus of claim 2, further comprising an indicia feature coupled to at least one of the capturing structure, the holding structure, the elongated member, and the gripping feature, wherein the indicia feature comprises at least one of a product marking, a patent marking, a product source, a trademark, a logo, a website address, a copyright notice, any identifying information, and the like.

13. The apparatus of claim 1, further comprising at least one hanging feature, the at least one hanging feature comprising at least one of a through-hole, a hook, an eye, an adhesive feature, and the like.

14. A method of fabricating a capturing apparatus, comprising:
providing a capturing structure having an upper portion and a lower portion;
providing a valve coupled with the capturing structure;
providing an elongated member having a proximal end and a distal end, the elongated member coupled with the capturing structure; and
providing a holding structure, having an upper portion and a lower portion, coupled with the capturing structure.

15. The method of claim 14, further comprising providing an actuator for actuating the valve.

16. The method of claim 14, wherein providing the capturing structure comprises providing at least one of a ridge, a crest, a point, a rim, an indent, an edge, a lip, a brim, and the like.

17. The method of claim 14, wherein providing the valve comprises providing at least one of a one-way valve, a valve actuable by an aerodynamic force, a valve actuable by a mechanical force, and the like.

18. The method of claim 15, wherein providing the actuator comprises providing at least one of a gear, a rail, a pulley, a chain, a linkage, a spring, a wire, a rod, a cable, a belt, a wheel and axle, a rack-and-pinion, and the like.

19. A method of using a capturing apparatus, comprising:
providing the capturing apparatus, the capturing apparatus providing comprising:
providing a capturing structure having an upper portion and a lower portion;
providing a valve coupled with the capturing structure;
providing an elongated member having a proximal end and a distal end, the elongated member coupled with the capturing structure; and
providing a holding structure, having an upper portion and a lower portion, coupled with the capturing structure; and
swooping the capturing apparatus in relation to an object, thereby capturing the object.

20. The method of claim 19, further comprising releasing the object.
